(19) United States
(12) Patent Application Publication
(10) Pub. No.: US 2026/0045687 A1
(43) Pub. Date: Feb. 12, 2026

(54) RETROREFLECTIVE ANTENNA, AND OBJECT DETECTING SYSTEM

(71) Applicant: Sumitomo Electric Industries, Ltd., Osaka-shi, Osaka (JP)

(72) Inventors: Kyohiro YOSHIDA, Osaka-shi, Osaka (JP); Eiji MOCHIDA, Osaka-shi, Osaka (JP)

(73) Assignee: Sumitomo Electric Industries, Ltd., Osaka-shi, Osaka (JP)

(21) Appl. No.: 19/101,904

(22) PCT Filed: Jun. 27, 2023
(86) PCT No.: PCT/JP2023/023792

§ 371 Date: Feb. 7, 2025

(30) Foreign Application Priority Data
Aug. 10, 2022 (JP) 2022-128219

(51) Int. Cl. H01Q 3/26; G01S 13/82

(52) U.S. Cl. CPC H01Q 3/2647; G01S 13/82

(57) ABSTRACT

A retroreflective antenna according to one embodiment includes: an antenna main body for retroreflecting incoming radio waves; and a passive notch filter, in which the antenna main body includes a plurality of pairs of antenna elements, and a plurality of transmission lines provided corresponding to the plurality of pairs of antenna elements, each pair of antenna elements in the plurality of pairs of antenna elements is disposed point-symmetrically with respect to a reference point in the antenna main body, each of the plurality of transmission lines connects corresponding pair of antenna elements among the plurality of pairs of antenna elements, electrical lengths of the plurality of transmission lines are the same, and the passive notch filter is provided in at least one transmission line among the plurality of transmission lines.

### TECHNICAL FIELD

The present disclosure relates to a retroreflective antenna and an object detecting system.

The present application claims priority to Japanese Patent Application No. 2022-128219 filed on Aug. 10, 2022, and the entire contents of the Japanese patent application are incorporated herein by reference.

### BACKGROUND ART

As one type of antenna, a Van Atta array antenna (Van Aatta array antenna) is known (see Patent Literatures 1, 2, and 3). The Van Atta array antenna has a plurality of pairs of antenna elements. Each of the plurality of pairs of antenna elements is disposed point-symmetrically with respect to a reference point. The pair of antenna elements disposed point-symmetrically with respect to the reference point are connected by a transmission line. Electrical lengths of the plurality of transmission lines corresponding to the plurality of pairs of antenna elements are the same. With the above configuration, the Van Atta array antenna retroreflects incoming radio waves. Since the Van Atta array antenna retroreflects the incoming radio waves, a reflected power when the radio waves are reflected by the Van Atta array antenna is relatively large. Therefore, it is easy to distinguish between reflection of radio waves by a reflector not having a retroreflection function and reflection of radio waves from the Van Atta array antenna. Therefore, the Van Atta array antenna can be used for object detection.

### CITATION LIST

### Patent Literature

Patent Literature 1: U.S. Pat. No. 2,908,202
Patent Literature 2: WO 00/59068 A
Patent Literature 3: US 2020/0194887 A

### SUMMARY OF INVENTION

A retroreflective antenna according to one aspect of the present disclosure includes: an antenna main body for retroreflecting incoming radio waves; and a passive notch filter, in which the antenna main body includes a plurality of pairs of antenna elements, and a plurality of transmission lines provided corresponding to the plurality of pairs of antenna elements, each pair of antenna elements in the plurality of pairs of antenna elements is disposed point-symmetrically with respect to a reference point in the antenna main body, each of the plurality of transmission lines connects corresponding pair of antenna elements among the plurality of pairs of antenna elements, electrical lengths of the plurality of transmission lines are the same, and the passive notch filter is provided in at least one transmission line among the plurality of transmission lines.

### BRIEF DESCRIPTION OF DRAWINGS

FIG. 1 is a schematic view of a retroreflective antenna according to one embodiment.

FIG. 2 is a plan view of an example of a mode embodying the retroreflective antenna illustrated in FIG. 1.

FIG. 3 is a side view of a substrate included in the retroreflective antenna illustrated in FIG. 1.

FIG. 4 is a schematic view of an object detecting system according to a second embodiment.

FIG. 5 is a view illustrating frequencies of a transmission wave and a reception wave in a radar device.

FIG. 6 is a view illustrating a difference frequency between the frequency of the transmission wave and the frequency of the reception wave illustrated in FIG. 5.

FIG. 7 is a schematic view of a retroreflective antenna according to a third embodiment.

FIG. 8 is a view illustrating a difference frequency between a frequency of a transmission wave and a frequency of a reception wave obtained in a case where the retroreflective antenna illustrated in FIG. 7 is applied to the object detecting system illustrated in FIG. 4.

FIG. 9 is a view of a retroreflective antenna according to a fourth embodiment as viewed from a front surface side.

FIG. 10 is a view of the retroreflective antenna illustrated in FIG. 9 as viewed from a back surface side.

FIG. 11 is a side view of a substrate included in the retroreflective antenna illustrated in FIG. 9.

FIG. 12 is a view illustrating a modification of the retroreflective antenna.

### DESCRIPTION OF EMBODIMENTS

### Problem to be Solved by Present Disclosure

As described above, the reflected power when the radio waves are reflected by the Van Atta array antenna is relatively large. However, it is difficult to distinguish between reflection from a reflector having a high radio wave reflection capability (is more likely to reflect radio waves) even when the reflector does not have a retroreflection function and reflection from a Van Atta array antenna. Therefore, for example, it is conceivable to superimpose predetermined information (identification information or the like) on the radio waves retroreflected by the Van Atta array antenna by using an input device of the predetermined information related to the retroreflective antenna. In this case, by reading the predetermined information, it is specified that the reflection is from the Van Atta array antenna. When such an input device is used, a battery and the like for supplying power to the device is required. As a result, there are problems such as an increase in the manufacturing cost of the Van Atta array antenna, an extra cost required for replacing the battery, and an increase in weight of the Van Atta array antenna.

An object of the present disclosure is to provide a retroreflective antenna capable of retroreflecting radio waves in a state where information is superimposed on incoming radio waves without requiring a power supply, and an object detecting system using the retroreflective antenna.

### Effects of Present Disclosure

According to the present disclosure, it is possible to provide a retroreflective antenna capable of retroreflecting radio waves in a state where information is superimposed on incoming radio waves without requiring a power supply, and an object detecting system using the retroreflective antenna.

### Description of Embodiments of Present Disclosure

First, contents of embodiments of the present disclosure are listed and described.

(1) A retroreflective antenna according to one aspect of the present disclosure includes: an antenna main body for retroreflecting incoming radio waves; and a passive notch filter, in which the antenna main body includes a plurality of pairs of antenna elements, and a plurality of transmission lines provided corresponding to the plurality of pairs of antenna elements, each pair of antenna elements in the plurality of pairs of antenna elements is disposed point-symmetrically with respect to a reference point in the antenna main body, each of the plurality of transmission lines connects corresponding pair of antenna elements among the plurality of pairs of antenna elements, electrical lengths of the plurality of transmission lines are the same, and the passive notch filter is provided in at least one transmission line among the plurality of transmission lines.

Since the retroreflective antenna according to (1) includes the antenna main body having the above configuration, the retroreflective antenna can retroreflect the incoming radio waves. At least one transmission line among the plurality of transmission lines included in the antenna main body is provided with the passive notch filter. In this case, by designing the passive notch filter so as to cut a part of a frequency of the incoming radio waves, the retroreflective antenna according to (1) retroreflects radio waves with a reflected power of a portion of the radio waves corresponding to the cut frequency attenuated. In this case, the presence of the attenuated portion of the radio waves corresponds to information being superimposed on the retroreflected radio waves. Since this information is superimposed on the radio waves by using the passive notch filter, a power supply is not required. Therefore, in the retroreflective antenna according to (1), it is possible to retroreflect the radio waves in a state where information is superimposed on the incoming radio waves without requiring a power supply.

(2) In the retroreflective antenna according to (1), the plurality of pairs of antenna elements may include a first antenna element group, a second antenna element group, and a third antenna element group, each of the first antenna element group, the second antenna element group, and the third antenna element group may include N (N is an integer of 1 or more) pairs of antenna elements, and when one of the N pairs of antenna elements in each of the first antenna element group, the second antenna element group, and the third antenna element group is defined as an i-th pair of antenna elements (i is 1 or more and N or less), the i-th pair of antenna elements in the second antenna element group may be disposed at positions obtained by rotating the i-th pair of antenna elements in the first antenna element group by 120 degrees about a predetermined direction of the reference point, and the i-th pair of antenna elements in the third antenna element group may be disposed at positions obtained by rotating the i-th pair of antenna elements in the first antenna element group by 240 degrees about the predetermined direction of the reference point.

In the above configuration, the i-th pair of antenna elements in the second antenna element group and the i-th pair of antenna elements in the third antenna element group are disposed at positions obtained by rotating the i-th pair of antenna elements in the first antenna element group by 120 degrees and 240 degrees about the predetermined direction of the reference point. Therefore, the arrangement of the transmission path connecting the i-th pair of antenna elements in the second antenna element group and the third antenna element group may also be an arrangement obtained by rotating the transmission path connecting the i-th pair of antenna elements in the first antenna element group with respect to the reference point. In this case, by designing the plurality of pairs of antenna elements included in the first antenna element group and the transmission lines connecting the antenna elements, the plurality of pairs of antenna elements included in the second antenna element group and the transmission lines connecting the antenna elements, and the plurality of pairs of antenna elements included in the third antenna element group and the transmission lines connecting the antenna elements can also be determined. As a result, in the above configuration, when the retroreflective antenna is designed, it is only necessary to design 1/3 of the retroreflective antenna. Therefore, the retroreflective antenna can be easily designed.

(3) In the retroreflective antenna according to (1) or (2), a plurality of the passive notch filters may be included, a number of the plurality of passive notch filters may be the same as a number of the plurality of transmission lines, frequencies cut by the plurality of passive notch filters may be the same, and each transmission line included in the plurality of transmission lines may be provided with each passive notch filter included in the plurality of passive notch filters.

In this case, in all the radio waves propagating through the plurality of transmission lines, a portion corresponding to the same frequency among the radio waves is cut. Therefore, in the retroreflected radio waves, the reflected power of the portion corresponding to the frequency cut by the passive notch filter is attenuated more greatly. As a result, the information superimposed on the radio waves is easily detected.

(4) In the retroreflective antenna according to (1) or (2), a plurality of notch filter groups may be included, each notch filter group in the plurality of notch filter groups may include a plurality of the passive notch filters configured to cut different frequencies, a number of the plurality of notch filter groups may be the same as a number of the plurality of transmission lines, and each notch filter group in the plurality of notch filter groups may be provided in each transmission line in the plurality of transmission lines.

In this case, each transmission line is provided with a plurality of passive notch filters configured to cut different frequencies. Therefore, the reflected powers of portions corresponding to the different frequencies among the retroreflected radio waves are attenuated. Therefore, the retroreflective antenna according to (4) can superimpose a large amount of information on the retroreflected radio waves.

(5) An object detecting system according to another aspect of the present disclosure includes: a retroreflective antenna attached to an object, which is the retroreflective antenna according to any one of (1) to (3); and a radar device that transmits radio waves modulated by an FMCW method and receives the radio waves retroreflected by the retroreflective antenna, in which a frequency cut by the passive notch filter included in the retroreflective antenna is a frequency within a frequency band of the radio waves.

In the object detecting system according to (5), the radar device transmits radio waves and receives the radio waves that are retroreflected by the retroreflective antenna. The radar device transmits radio waves modulated by the FMCW method. Therefore, the frequency of the radio waves transmitted from the radar device is linearly modulated temporally. Therefore, the frequency of the received radio waves also changes temporally in the same manner. The retroreflective antenna included in the object detecting system according to (5) is the retroreflective antenna according to any one of (1) to (3). Therefore, in the radio waves retroreflected by the retroreflective antenna, the reflected power of a portion of the radio waves corresponding to the frequency cut by the passive notch filter is attenuated. In this way, the portion of the radio waves transmitted from the radar device corresponding to the frequency cut by the passive notch filter is received by the radar device with reduced reception intensity. Therefore, whether or not the reflection is from the retroreflective antenna is specified depending on a reception state of the radio waves in the radar device. As a result, an object to which the retroreflective antenna is attached is detected.

(6) In the object detecting system according to (5), a plurality of

notch filter groups may be included, each notch filter group in the plurality of notch filter groups may include a plurality of the passive notch filters configured to cut different frequencies, a number of the plurality of notch filter groups may be the same as a number of the plurality of transmission lines, and each notch filter group in the plurality of notch filter groups may be provided in each transmission line in the plurality of transmission lines. In this case, each transmission line included in the retroreflective antenna is provided with a plurality of passive notch filters configured to cut different frequencies. Therefore, since the reflected power of each portion corresponding to the different frequencies among the retroreflected radio waves is attenuated, the retroreflective antenna can superimpose a large amount of information on the retroreflected radio waves. Therefore, in the object detecting system according to (6), it is easy to distinguish the object to which the retroreflective antenna is attached from other objects. In this case, for example, it is possible to manage the object using the object detecting system.

### DETAILS OF EMBODIMENTS OF PRESENT DISCLOSURE

Specific examples of the embodiments of the present disclosure will now be described with reference to the drawings. It should be noted that the present invention is not limited to these examples, is described by the claims, and is intended to include meanings equivalent to the claims and all changes within the scope of the claims. In the description of the drawings, the same elements are denoted by the same reference signs, and a repeated description is omitted.

### First Embodiment

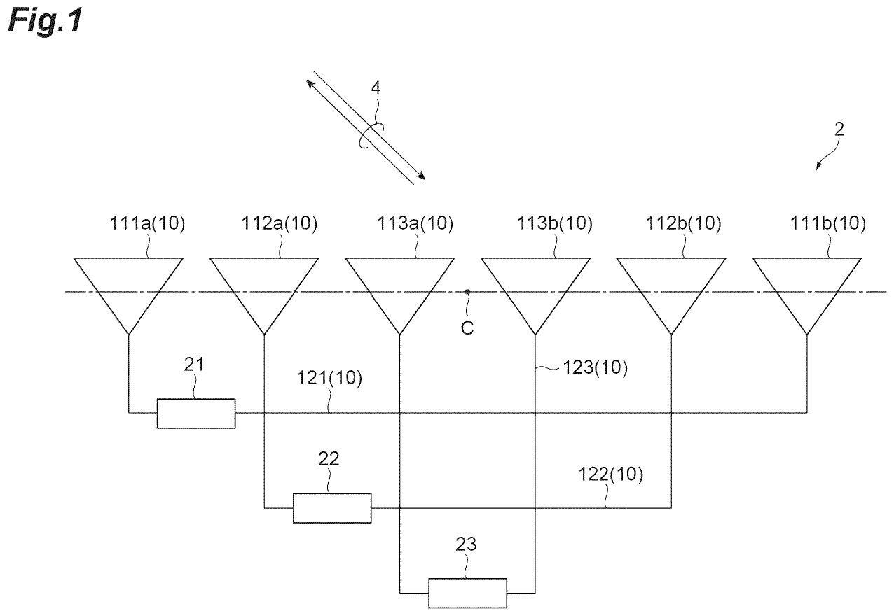

FIG. 1 is a schematic view of a retroreflective antenna 2 according to one embodiment. An outline of the retroreflective antenna 2 according to one embodiment will be described with reference to FIG. 1.

The retroreflective antenna 2 is an antenna that reflects radio waves 4 incoming from a predetermined direction in an opposite direction along the predetermined direction (that is, retroreflects). The radio waves 4 are, for example, millimeter waves. A frequency band of the millimeter waves is from 30 GHz to 300 GHz. In the first embodiment, the radio waves 4 incoming to the retroreflective antenna 2 are radio waves from a transmission source. In the first embodiment, the transmission source is a sensor (for example, a radar device) for object detection. An example of the radio waves 4 is radio waves modulated by a FMCW (frequency modulation continuous wave) method.

The retroreflective antenna 2 includes an antenna main body 10 for retroreflecting the incoming radio waves 4 and three notch filters 21, 22, and 23.

The antenna main body 10 includes three pairs of antenna elements 111a and 111b, 112a and 112b, and 113a and 113b, and three transmission lines 121, 122, and 123. In this mode, the antenna main body 10 has six antenna elements 111a, 111b, 112a, 112b, 113a, and 113b. Hereinafter, the three pairs of antenna elements 111a and 111b, 112a and 112b, and 113a and 113b may be referred to as “pairs of antenna elements 111a, 111b, and the like”, and the six antenna elements 111a, 111b, 112a, 112b, 113a, and 113b may be referred to as “antenna elements 111a, 111b, and the like”.

Each of the six antenna elements 111a, 111b, and the like is configured to be able to receive the radio waves 4 and emit the radio waves 4.

The six antenna elements 111a, 111b, and the like are disposed in an order of the antenna element 111a, the antenna element 112a, the antenna element 113a, the antenna element 113b, the antenna element 112b, and the antenna element 111b on an alternate long and short dash line illustrated for convenience of description in FIG. 1.

The three pairs of antenna elements 111a, 111b, and the like (in other words, the six antenna elements 111a, 111b, and the like) are disposed to satisfy the following condition I.

### [Condition I]

A pair of antenna elements are disposed point-symmetrically with respect to a reference point of the antenna main body.

Therefore, the pair of antenna elements 111a and 111b are disposed point-symmetrically with respect to a reference point C of the antenna main body 10.

The pair of antenna elements 112a and 112b are disposed point-symmetrically with respect to the reference point C.

The pair of antenna elements 113a and 113b are disposed point-symmetrically with respect to the reference point C.

The transmission line 121, the transmission line 122, and the transmission line 123 are lines that transmit the radio waves 4. The transmission line 121 connects the antenna element 111a and the antenna element 111b. The transmission line 122 connects the antenna element 112a and the antenna element 112b. The transmission line 123 connects the antenna element 113a and the antenna element 113b. Electrical lengths of the transmission line 121, the transmission line 122, and the transmission line 123 are the same. The transmission line 121, the transmission line 122, and the transmission line 123 are not connected to each other.

The notch filter 21 is provided in the transmission line 121. The notch filter 22 is provided in the transmission line 122. The notch filter 23 is provided in the transmission line 123. In the first embodiment, the notch filter 21, the notch filter 22, and the notch filter 23 are filters configured to cut a part of the frequency of the frequency band of the radio waves 4. The frequencies cut by the notch filter 21, the notch filter 22, and the notch filter 23 are the same. The notch filters 21, 22, and 23 are passive notch filters.

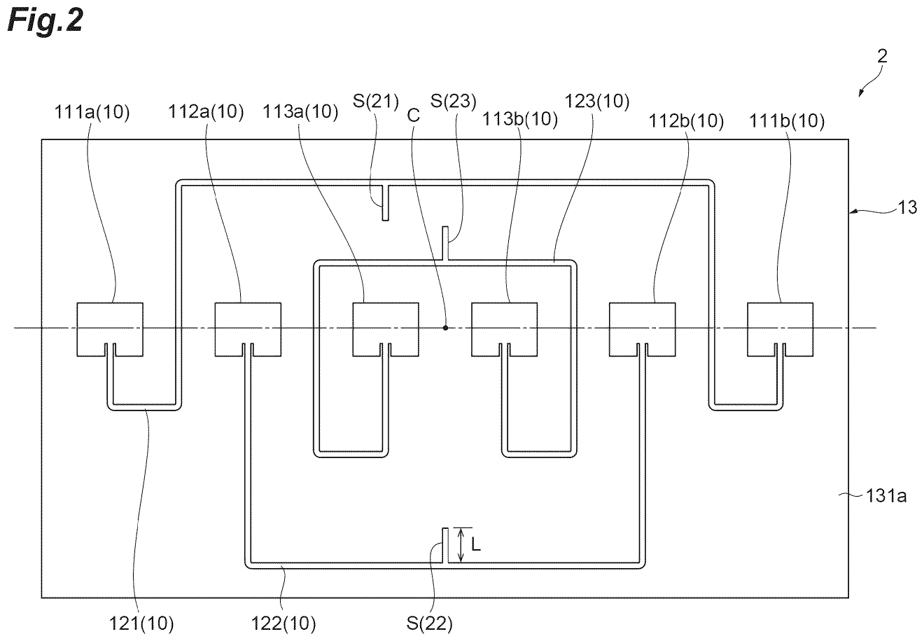

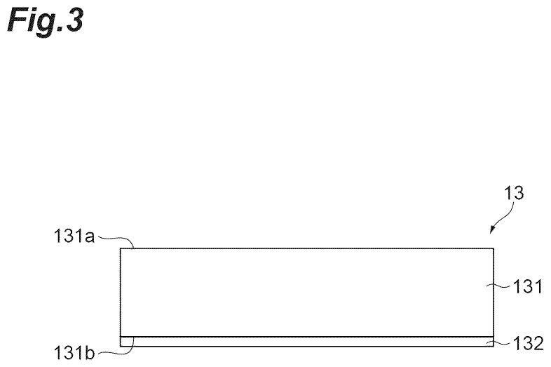

The retroreflective antenna 2 will be further described with reference to FIGS. 2 and 3. FIG. 2 is a plan view of an example of a mode embodying the retroreflective antenna 2 illustrated in FIG. 1. FIG. 3 is a side view of a substrate 13 used for the retroreflective antenna 2 illustrated in FIG. 1.

One mode of the retroreflective antenna 2 illustrated in FIG. 2 is a mode in which the retroreflective antenna 2 conceptually illustrated in FIG. 1 is embodied by using a microstrip structure. Therefore, the retroreflective antenna 2 illustrated in FIG. 2 includes the antenna main body 10 and the notch filters 21, 22, and 23. In the retroreflective antenna 2, the antenna main body 10 and the notch filters 21, 22, and 23 are mounted on the substrate 13.

As illustrated in FIG. 3, the substrate 13 includes a dielectric layer 131 and a ground conductor layer 132. Examples of a material of the dielectric layer 131 include Teflon (registered trademark) and aluminum oxide. The ground conductor layer 132 is formed on a back surface 131b of the dielectric layer 131. A material of the ground conductor layer 132 is metal (for example, copper, silver, tungsten, molybdenum, and the like).

The antenna main body 10 is formed on a front surface 131a of the dielectric layer 131.

Specifically, the six antenna elements 111a, 111b, and the like included in the antenna main body 10 are formed in a rectangular (or square) patch shape. Each of the six antenna elements 111a, 111b, and the like is realized as, for example, a conductive film. Examples of a material of the conductive film include a metal (for example, copper, silver, tungsten, molybdenum, and the like). Sizes of the six antenna elements 111a, 111b, and the like are set so that the radio waves 4 can be transmitted and received.

An arrangement relationship of the six antenna elements 111a, 111b, and the like is the same as the arrangement relationship described with reference to FIG. 1. That is, each of the pair of antenna elements 111a and 111b, the pair of antenna elements 112a and 112b, and the pair of antenna elements 113a and 113b is disposed point-symmetrically with respect to the reference point C of the antenna main body 10.

The transmission line 121 is formed as a linear conductive film that connects the pair of antenna elements 111a and 111b. The transmission line 122 is formed as a linear conductive film that connects the pair of antenna elements 112a and 112b. The transmission line 123 is formed as a linear conductive film that connects the pair of antenna elements 113a and 113b. An example of the material of the conductive film functioning as the transmission line 121, 122, and 123 is the same as that of the antenna element 111a. The transmission lines 121, 122, and 123 in the retroreflective antenna 2 illustrated in FIG. 2 are microstrip lines. In the first embodiment, the material, thickness, and width of the transmission lines 121, 122, and 123 are the same. The electrical lengths of the transmission lines 121, 122, and 123 are the same as described above. The electrical lengths of the transmission lines 121, 122, and 123 are adjusted by their paths, for example.

The notch filter 21 is formed as a stub S continuously branched from a part of the transmission line 121. The notch filter 22 is formed as a stub S continuously branched from a part of the transmission line 122. The notch filter 23 is formed as a stub S continuously branched from a part of the transmission line 122. Each stub S provided in the transmission lines 121, 122, and 123 is formed of the same conductive film as the transmission lines 121, 122, and 123.

A length L of the stub S provided in each of the transmission lines 121, 122, and 123 is a length from an end portion of the stub S on the corresponding transmission lines 121, 122, and 123 side to a free end of the stub S. The length L of the stub S is set by the following Formula 1.

$$L = ( 1 / 4 ) \times λ + n \times ( λ / 2 ) \qquad ( Formula 1 )$$

In Formula 1, λ is a wavelength corresponding to a frequency cut by the stubs S which are the notch filters 21, 22, and 23. n is an integer of 0 or more.

The retroreflective antenna 2 illustrated in FIG. 2 can be manufactured, for example, as follows. First, the substrate 13 is prepared. Thereafter, the antenna main body 10 and the stub S are formed on the front surface 131a of the dielectric layer 131 by, for example, a printing technique. Thus, the retroreflective antenna 2 is manufactured.

The configuration of the antenna main body 10 in the retroreflective antenna 2 illustrated in FIGS. 1 and 2 corresponds to a configuration of the Van Atta array antenna. Therefore, the antenna main body 10 can retroreflect the incoming radio waves 4.

For example, a case where the radio waves 4 from a transmission source are incident on the retroreflective antenna 2 at an angle, and a wavefront of the radio waves 4 reaches the antenna elements 111a, 112a, 113a, 113b, 112b, and 111b in this order will be considered. In this case, the radio waves 4 sequentially incident on the antenna elements 111a, 112a, and 113a propagate through the transmission lines 121, 122, and 123, respectively, and are emitted from the antenna elements 111b, 112b, and 113b paired with the antenna elements 111a, 112a, and 113a, respectively. Similarly, following the incidence of the radio waves 4 on the antenna element 113a, the radio waves 4 incident on the antenna elements 113b, 112b, and 111b propagate through the transmission lines 123, 122, and 121, respectively, and are emitted from the antenna elements 113a, 112a, and 111a paired with the antenna elements 113b, 112b, and 111b, respectively. Since the electrical lengths of the transmission lines 121, 122, and 123 are the same, times required for the radio waves 4 to propagate through the transmission lines 121, 122, and 123 are the same. In this case, the radio waves 4 incident on the antenna elements 111a, 112a, 113a, 113b, 112b, and 111b in this order are emitted from the antenna elements 111b, 112b, 113b, 113a, 112a, and 111a in this order after a certain delay time. As a result, the radio waves 4 incoming to the retroreflective antenna 2 can be reflected in the opposite direction (that is, toward the transmission source) along the incoming direction.

In the retroreflective antenna 2, the notch filters 21, 22, and 23 (stubs S in FIG. 2) are provided in the transmission line 121 connecting the pair of antenna elements 111a and 111b, the transmission line 122 connecting the pair of antenna elements 112a and 112b, and the transmission line 123 connecting the pair of antenna elements 113a and 113b. Therefore, when the radio waves 4 propagate through the transmission lines 121, 122, and 123, portions of the radio waves 4 corresponding to the frequencies cut by the notch filters 21, 22, and 23 are attenuated. Therefore, in the radio waves 4 retroreflected from the retroreflective antenna 2, the reflected powers of the portions corresponding to the frequencies cut by the notch filters 21, 22, and 23 are reduced. In this manner, the state of the radio waves 4 can be changed by the notch filters 21, 22, and 23. The variation of the radio waves 4 corresponds to predetermined information. Therefore, the retroreflective antenna 2 can retroreflect the radio waves 4 in a state where predetermined information (for example, identification information of the retroreflective antenna 2) is superimposed on the incoming radio waves 4.

The notch filters 21, 22, and 23 are passive filters. Therefore, unlike an active filter, a power supply to the notch filters 21, 22, and 23 is not required. Therefore, in the retroreflective antenna 2, the radio waves 4 can be retroreflected in a state where the predetermined information is superimposed on the incoming radio waves 4 without requiring a power supply.

Since a power supply to the retroreflective antenna 2 is not required, the retroreflective antenna 2 does not need a region for mounting a battery for a power supply. Therefore, the retroreflective antenna 2 can be downsized (or thinned). Since the battery is unnecessary as described above, the manufacturing cost of the retroreflective antenna 2 is reduced. Furthermore, there is no need for the cost (additional purchase cost of the battery, and the like) for continuing the use of the retroreflective antenna 2.

For example, a sensor (for example, a millimeter wave radar sensor) using radio waves is attached to an automobile in order to detect a bicycle, a person (pedestrian), and the like.

The retroreflective antenna 2 can retroreflect the radio waves 4 in a state where predetermined information (for example, identification information of the retroreflective antenna 2) based on the frequencies cut by the notch filters 21, 22, and 23 is superimposed on the incoming radio waves 4. Therefore, when an automobile detects an object by using a sensor as described above, it is easy to distinguish between reflection from an object (for example, a sign) having relatively large reflected power and reflection from the retroreflective antenna 2. The sensor mounted on the automobile transmits the radio waves 4 modulated by the FMCW method, that is, radio waves whose frequency is linearly modulated temporally. Therefore, when the radio waves 4 from the sensor are retroreflected by the retroreflective antenna 2, the predetermined information based on the frequencies cut by the notch filters 21, 22, and 23 is more reliably superimposed on the radio waves 4. Therefore, the retroreflective antenna 2 is effective when the incoming radio waves 4 are radio waves modulated by the FMCW method.

In the retroreflective antenna 2, the notch filters 21, 22, and 23 are provided in the transmission lines 121, 122, and 123. Therefore, in the radio waves 4 propagating through each transmission lines 121, 122, and 123, portions corresponding to the frequencies cut by the notch filters 21, 22, and 23 are attenuated. As a result, in the radio waves 4 retroreflected from the retroreflective antenna 2, attenuation amounts of the reflected powers of the portions corresponding to the frequencies cut by the notch filters 21, 22, and 23 are large. As a result, the predetermined information superimposed on the retroreflected radio waves 4 is easily detected.

### Second Embodiment

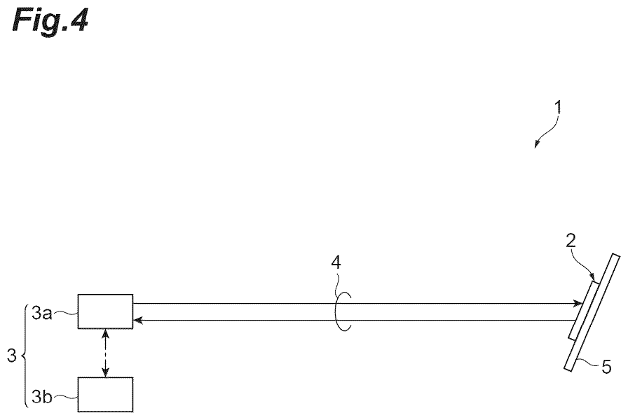

In a second embodiment, an object detecting system using the retroreflective antenna 2 described in the first embodiment will be described. FIG. 4 is a schematic view of an object detecting system 1 according to the second embodiment.

In the second embodiment, a case where the retroreflective antenna 2 is attached to an object 5 (including a case where the retroreflective antenna 2 is built in) will be described. The object 5 is, for example, a reflecting plate attached to a bicycle, a hat, a bag (including a school backpack), or the like, a reflecting vest of a worker at a construction site, or the like.

The object detecting system 1 includes a retroreflective antenna 2 and a radar device (sensor device) 3. The retroreflective antenna 2 is the same as the retroreflective antenna 2 illustrated in FIG. 2. Therefore, description of the retroreflective antenna 2 is omitted.

The radar device 3 includes a radar main body 3a and a control device 3b. The radar device 3 is mounted on an automobile, for example. The radar device 3 detects an object around the radar device 3.

The radar main body 3a transmits the radio waves 4 and receives the radio waves 4 transmitted from the radar main body 3a and reflected by surrounding objects. In one embodiment, the radar main body 3a includes a transmitting antenna that transmits the radio waves 4 and a receiving antenna that receives the radio waves 4. In one embodiment, the transmitting antenna and the receiving antenna may be a common antenna. The radio waves 4 transmitted by the radar main body 3a are, for example, millimeter waves.

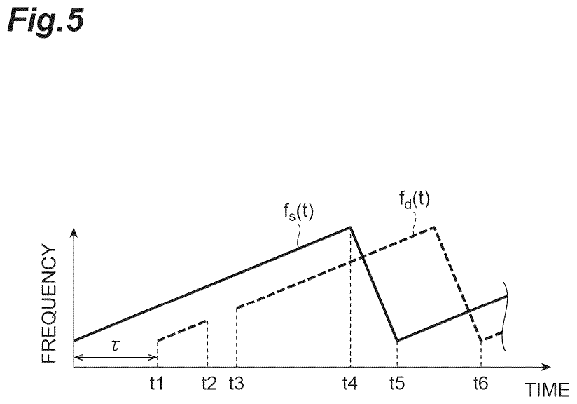

The radar main body 3a transmits the radio waves 4 modulated by the FMCW method. In this case, as indicated by a solid line in FIG. 5, the radar main body 3a transmits the radio waves 4 whose frequency is linearly modulated with a lapse of time. Hereinafter, the radio waves 4 transmitted by the radar main body 3a may be referred to as a transmission wave, and the radio waves received by the radar main body 3a may be referred to as a reception wave.

The control device 3b controls the radar main body 3a. Specifically, the control device 3b has a function of switching between a case where the radio waves 4 are transmitted from the radar main body 3a and a case where the radio waves 4 are not transmitted, a function of controlling the radar main body 3a so that the radar main body 3a transmits the radio waves 4 modulated by the FMCW method, and the like. The control device 3b detects the object 5 by using at least the reception wave. The control device 3b is, for example, a computer. The control device 3b may be a device dedicated to the radar device 3, or may cause a computer included in a device (an automobile in the second embodiment) on which the radar device 3 is mounted to execute a program for object detection, thereby causing the computer to function as the control device 3b.

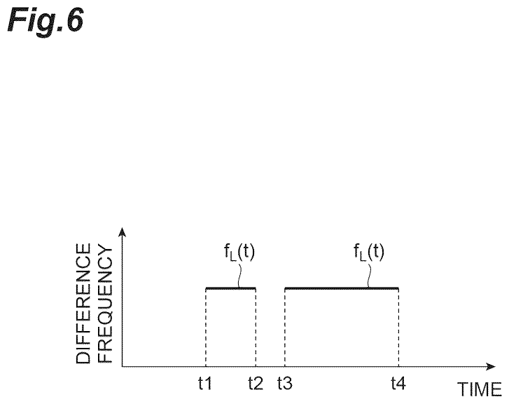

An example of a detection principle of the object 5 in the object detecting system 1 will be described with reference to FIGS. 5 and 6. FIG. 5 is a view illustrating frequencies of the transmission wave and the reception wave in the radar device 3. In FIG. 5, a horizontal axis represents a time and a vertical axis represents a frequency. A frequency fₛ(t) indicated by a solid line in FIG. 5 indicates a frequency of the transmission wave, and a frequency f_{d}(t) indicated by a broken line indicates a frequency of the reception wave.

FIG. 6 is a view illustrating a difference frequency f_{L}(t) between the frequency of the transmission wave and the frequency of the reception wave illustrated in FIG. 5. In FIG. 5, a horizontal axis represents a time, and a vertical axis represents a difference frequency. The times t1, t2, and the like in FIG. 6 are the same as the times t1, t2, and the like in FIG. 5.

When receiving the reception wave, the control device 3b calculates the difference frequency f_{L}(t) by the following Formula 2.

$${f}_{L} ( t ) = {f}_{s} ( t ) - {f}_{d} ( t ) \qquad Formula 2$$

The reception wave corresponding to the frequency f_{d}(t) indicated by a broken line in FIG. 5 is the radio waves 4 reflected by the retroreflective antenna 2. Therefore, the reception wave is received by the radar device 3 after a certain delay time (τ) following the transmission of the transmission wave from the radar device 3. The radio waves 4 transmitted from the radar main body 3a are modulated by the FMCW method, and the frequency linearly changes temporally. Therefore, the frequency of the radio waves 4 reflected by the retroreflective antenna 2 similarly changes temporally.

Since the reception wave is the radio waves 4 reflected by the retroreflective antenna 2, the frequency cut by the stub S (notch filter) is missing at the frequency f_{d}(t) of the reception wave as illustrated in FIG. 5. Therefore, as illustrated in FIG. 5, the reception wave is interrupted during a period (between time t2 and time t3 in FIG. 5) in which a portion of the transmission wave (radio waves 4) corresponding to the frequency cut by the stub S (notch filter) returns to the radar main body 3a. Therefore, a part of the difference frequency f_{L}(t) illustrated in FIG. 6 is also missing. The control device 3b detects that the reception wave is the reception wave from the retroreflective antenna 2 by recognizing the missing of the difference frequency f_{d}(t) (alternatively, a discontinuous portion of the reception wave). As a result, the radar device 3 can selectively detect the object 5 to which the retroreflective antenna 2 is attached.

### Third Embodiment

In the first embodiment, as illustrated in FIG. 1, the mode in which one notch filter 21 is provided in the transmission line 121, one notch filter 22 is provided in the transmission line 122, and one notch filter 23 is provided in the transmission line 123 has been described. However, each of the transmission lines 121, 122, and 123 may be provided with a plurality of notch filters. As a third embodiment, a mode in which a plurality of notch filters are provided in each of the transmission lines 121, 122, and 123 will be described.

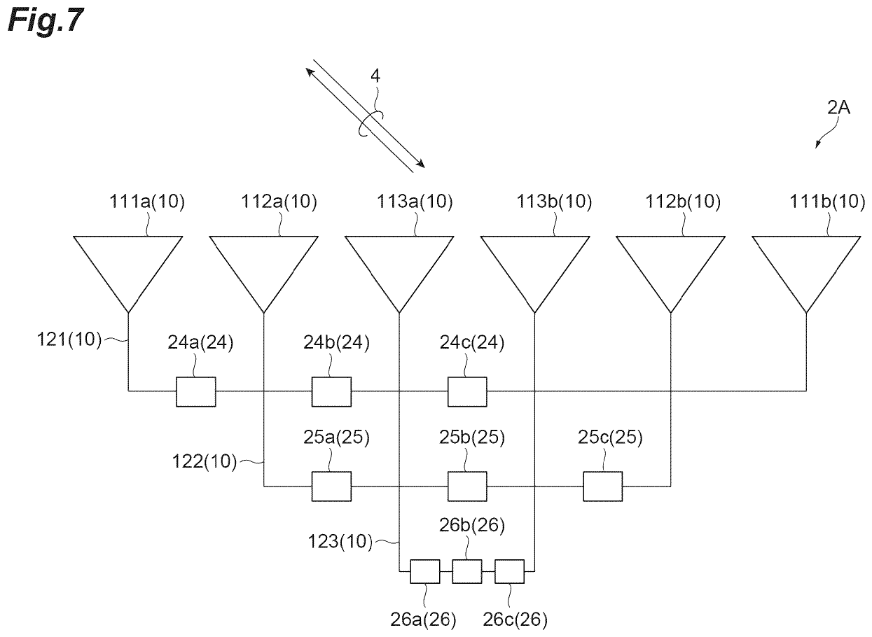

FIG. 7 is a schematic view of a retroreflective antenna 2A according to a third embodiment. The retroreflective antenna 2A includes an antenna main body 10 and notch filter groups 24, 25, and 26.

The configuration of the antenna main body 10 is the same as that of the first embodiment. Therefore, the description of the antenna main body 10 is omitted.

The notch filter group 24 is provided in the transmission line 121. The notch filter group 24 includes three notch filters 24a, 24b, and 24c. The notch filters 24a, 24b, and 24c are passive notch filters. Frequencies cut by the notch filters 24a, 24b, and 24c are different frequencies. Here, a frequency cut by the notch filter 24a is referred to as a first frequency, a frequency cut by the notch filter 24b is referred to as a second frequency, and a frequency cut by the notch filter 24c is referred to as a third frequency. In this case, the notch filter group 24 cuts portions corresponding to the first frequency, the second frequency, and the third frequency in the radio waves 4 propagating through the transmission line 121.

The notch filter group 25 is provided in the transmission line 122. The notch filter group 25 includes three notch filters 25a, 25b, and 25c. The notch filters 25a, 25b, and 25c are passive notch filters. A frequency cut by the notch filter 25a is the first frequency. A frequency cut by the notch filter 25b is the second frequency. A frequency cut by the notch filter 25c is the third frequency. In this case, the notch filter group 25 cuts portions corresponding to the first frequency, the second frequency, and the third frequency in the radio waves propagating through the transmission line 122.

The notch filter group 26 is provided in the transmission line 123. The notch filter group 26 includes three notch filters 26a, 26b, and 26c. The notch filters 26a, 26b, and 26c are passive notch filters. A frequency cut by the notch filter 26a is the first frequency. A frequency cut by the notch filter 26b is the second frequency. A frequency cut by the notch filter 26c is the third frequency. In this case, the notch filter group 26 cuts portions corresponding to the first frequency, the second frequency, and the third frequency in the radio waves propagating through the transmission line 123.

When the antenna main body 10 and the notch filter groups 24, 25, and 26 are mounted on the substrate 13 illustrated in FIG. 3, the notch filters 24a, 24b, 24c, 25a, 25b, 25c, 26a, 26b, and 26c can be formed as stubs S similarly to the case of the retroreflective antenna 2 illustrated in FIG. 2.

In the retroreflective antenna 2A, the radio waves 4 incoming to the retroreflective antenna 2A are retroreflected by the antenna main body 10.

The transmission lines 121, 122, and 123 included in the retroreflective antenna 2A are provided with the notch filter groups 24, 25, and 26. As described above, the notch filter groups 24, 25, and 26 attenuate the portions corresponding to the first frequency, the second frequency, and the third frequency in the radio waves 4 propagating through the transmission lines 121, 122, and 123. Therefore, the retroreflective antenna 2A can retroreflect the radio waves 4 in a state where predetermined information defined by the first frequency, the second frequency, and the third frequency is superimposed on the radio waves incoming to the retroreflective antenna 2A. In this case, the predetermined information is information defined based on three frequencies instead of one frequency. Therefore, more detailed information can be superimposed on the radio waves 4 as the predetermined information. As a result, the object to which the retroreflective antenna 2A is attached can be easily distinguished by the retroreflected radio waves 4 from the retroreflective antenna 2A.

The retroreflective antenna 2A can be applied to the object detecting system described in the second embodiment. In this case, the retroreflective antenna 2A is used instead of the retroreflective antenna 2 illustrated in FIG. 4.

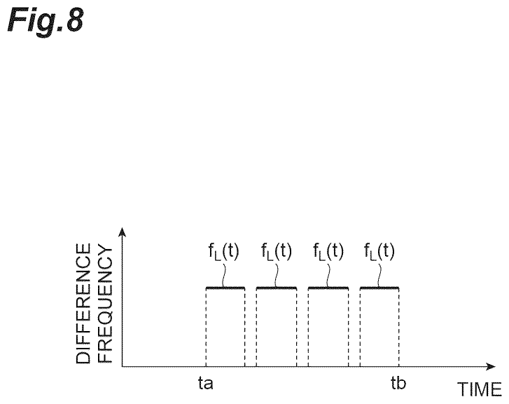

In a case where the retroreflective antenna 2A is applied to the object detecting system described in the second embodiment, when the radar device 3 receives a reception wave, a difference frequency f_{L}(t) illustrated in FIG. 8 is obtained. That is, since the portions corresponding to the first frequency, the second frequency, and the third frequency are attenuated in the radio waves 4 retroreflected from the retroreflective antenna 2A, three missing portions occur at the difference frequency f_{L}(t). Therefore, for example, when the missing portion is referred to as “0” and the portion other than the missing portion is referred to as “1”, a binary signal corresponding to the retroreflective antenna 2A can be obtained. This binary signal can be changed by adjusting a plurality of frequencies cut by the notch filter groups 24, 25, and 26. Therefore, for example, by adjusting the first frequency, the second frequency, and the third frequency cut by the notch filter groups 24, 25, and 26 according to the object to which the retroreflective antenna 2A is attached, it is possible to distinguish and detect the object to which the retroreflective antenna 2A is attached.

Since the retroreflective antenna 2A includes the notch filter groups 24, 25, and 26, the radio waves 4 can be retroreflected in a state where the predetermined information related to the retroreflective antenna 2A (or related to the object to which the retroreflective antenna 2A is attached) is superimposed on the radio waves 4 based on the three different frequencies as described above. Therefore, the retroreflective antenna 2A is, for example, a reflector in which an information code indicating the predetermined information is written. In a case where such a retroreflective antenna 2A is applied to the object detecting system described in the second embodiment, the radar device 3 corresponds to a reading device of the information code. In this case, for example, the object can be managed by using the retroreflective antenna 2A and the object detecting system using the retroreflective antenna 2A.

### Fourth Embodiment

In the first embodiment, the mode in which the plurality of antenna elements included in the retroreflective antenna are linearly (one-dimensionally) disposed has been described. The plurality of antenna elements may be disposed two-dimensionally. In a fourth embodiment, a mode in which a plurality of antenna elements are two-dimensionally disposed will be described.

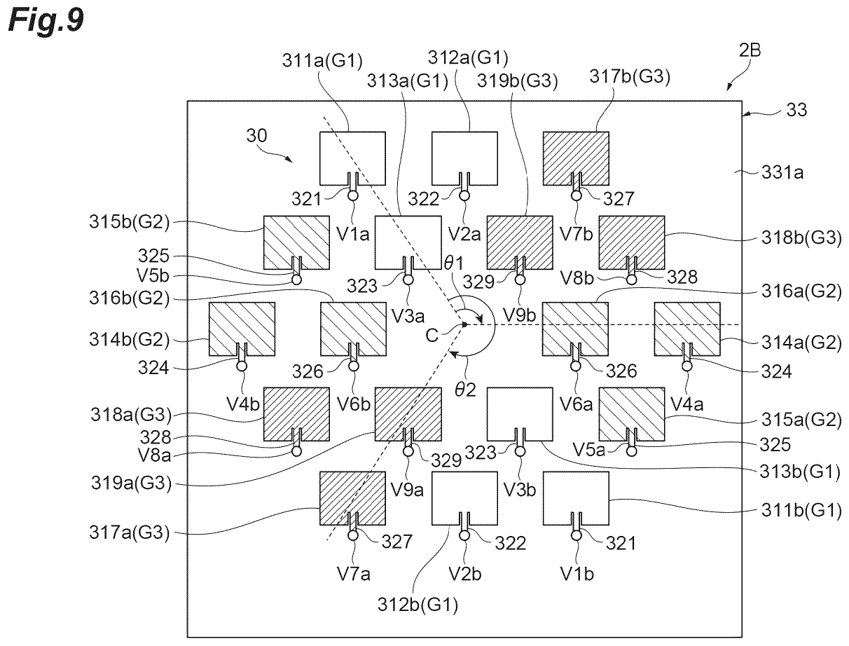

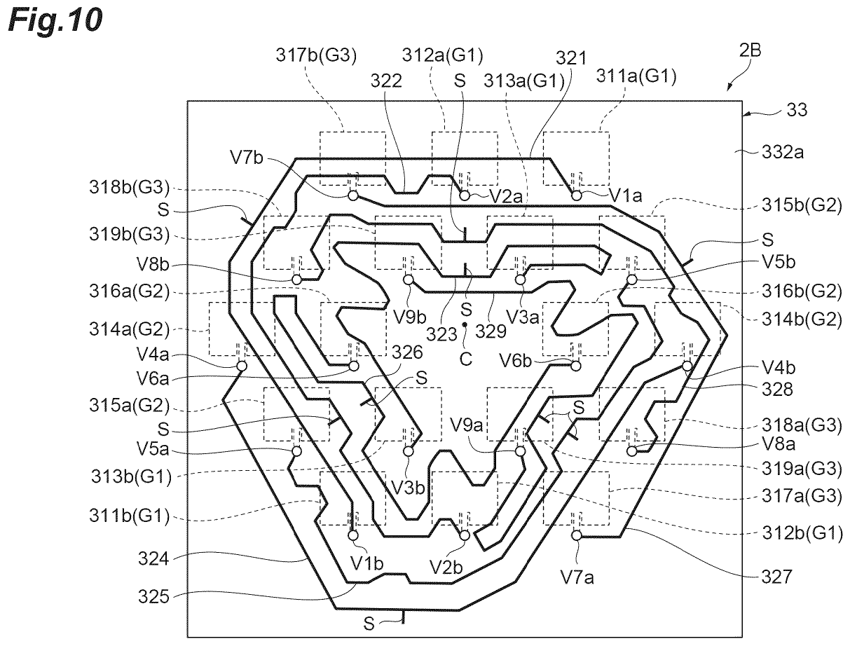

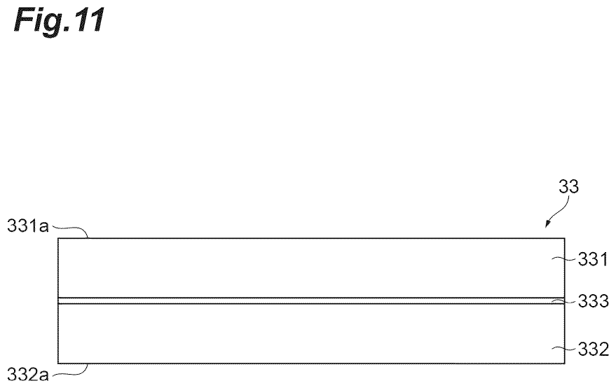

FIG. 9 is a view of a retroreflective antenna 2B according to the fourth embodiment as viewed from the front surface side. FIG. 10 is a view of the retroreflective antenna 2B illustrated in FIG. 9 as viewed from the back surface side. FIG. 11 is a side view of a substrate 33 included in the retroreflective antenna 2B illustrated in FIG. 9.

As illustrated in FIGS. 9 and 10, the retroreflective antenna 2B includes an antenna main body 30 and nine stubs (notch filters) S. The antenna main body 30 and the stubs S are mounted on the substrate 33.

First, the substrate 33 will be described. As illustrated in FIG. 11, the substrate 33 includes a dielectric layer 331, a dielectric layer 332, and a conductor layer 333. The dielectric layer 332, the conductor layer 333, and the dielectric layer 331 are laminated in this order. Examples of a material of the dielectric layer 331 and the dielectric layer 332 are the same as those in the case of the dielectric layer 131 illustrated in FIG. 3. Examples of a material of the conductor layer 333 are the same as that of the ground conductor layer 132 illustrated in FIG. 3.

Next, the antenna main body 30 and the stub S will be described.

As illustrated in FIGS. 9 and 10, the antenna main body 30 includes nine pairs of antenna elements, that is, a pair of antenna elements 311a and 311b, a pair of antenna elements 312a and 312b, a pair of antenna elements 313a and 313b, a pair of antenna elements 314a and 314b, a pair of antenna elements 315a and 315b, a pair of antenna elements 316a and 316b, a pair of antenna elements 317a and 317b, a pair of antenna elements 318a and 318b, and a pair of antenna elements 319a and 319b.

Therefore, the antenna main body 30 includes 18 antenna elements 311a, 311b, 312a, 312b, 313a, 313b, 314a, 314b, 315a, 315b, 316a, 316b, 317a, 317b, 318a, 318b, 319a, and 319b.

Hereinafter, the nine pairs of antenna elements may be referred to as “pairs of antenna elements 311a, 311b, and the like”, and the 18 antenna elements may be referred to as “antenna elements 311a, 311b, and the like”.

The arrangement relationship between the pair of antenna elements 311a and 311b is the same as the arrangement relationship between the pair of antenna elements 111a and 111b in the first embodiment. That is, the pair of antenna elements 311a and 311b are disposed point-symmetrically with respect to the reference point C of the antenna main body 30. The same applies to the pair of antenna elements 312a and 312b, the pair of antenna elements 313a and 313b, the pair of antenna elements 314a and 314b, the pair of antenna elements 315a and 315b, the pair of antenna elements 316a and 316b, the pair of antenna elements 317a and 317b, the pair of antenna elements 318a and 318b, and the pair of antenna elements 319a and 319b. Therefore, the arrangement relationship of the pairs of antenna elements 311a, 311b, and the like satisfies the above condition I.

The nine antenna elements 311a, 311b, and the like are formed on a front surface 331a of the dielectric layer 331. Shapes of the antenna elements 311a, 311b, and the like, and materials of the antenna elements 311a, 311b, and the like are the same as those of the antenna element 111a in the first embodiment. The nine antenna elements 311a, 311b, and the like are formed by, for example, a printing technique.

As illustrated in FIG. 9, the nine antenna elements 311a, 311b, and the like are disposed in a hexagonal shape centered on the reference point C. In the embodiment illustrated in FIG. 9, the antenna elements 311a, 312a, 317b, 318b, 314a, 315a, 311b, 312b, 317a, 318a, 314b, and 315b are disposed in a hexagonal shape. The antenna elements 311a, 312a, 317b, 318b, 314a, 315a, 311b, 312b, 317a, 318a, 314b, and 315b are disposed clockwise with respect to the reference point C in this order. A virtual hexagon formed by the antenna elements 311a, 312a, 317b, 318b, 314a, 315a, 311b, 312b, 317a, 318a, 314b, and 315b is referred to as a first hexagon.

The antenna elements 311a, 317b, 314a, 311b, 317a, and 314b are disposed at corners of the first hexagon.

The antenna element 312a is disposed at the center between the antenna elements 311a and 317b.

The antenna element 318b is disposed at the center between the antenna elements 317b and 314a.

The antenna element 315a is disposed at the center between the antenna elements 314a and 311b.

The antenna element 312b is disposed at the center between the antenna elements 311b and 317a.

The antenna element 318a is disposed at the center between the antenna elements 317a and 314b.

The antenna element 315b is disposed at the center between the antenna elements 314b and 311a.

The antenna elements 313a, 319b, 316a, 313b, 319a, and 316b are disposed in a hexagonal shape inside the first hexagon. The antenna elements 313a, 319b, 316a, 313b, 319a, and 316b are disposed clockwise with respect to the reference point C in this order. A virtual hexagon formed by the antenna elements 313a, 319b, 316a, 313b, 319a, and 316b is referred to as a second hexagon. The antenna elements 313a, 319b, 316a, 313b, 319a, and 316b are disposed at corners of the second hexagon.

In the antenna main body 30, as described above, the 18 antenna elements 311a, 311b, and the like are disposed on the virtual first hexagon and second hexagon having different sizes centered on the reference point C.

In the mode in which the 18 antenna elements 311a, 311b, and the like are disposed in a hexagonal shape, the nine pairs of antenna elements 311a, 311b, and the like can be divided into three antenna element groups. In the fourth embodiment, the antenna main body 30 includes a first antenna element group G1, a second antenna element group G2, and a third antenna element group G3.

The first antenna element group G1 includes the pair of antenna elements 311a and 311b, the pair of antenna elements 312a and 312b, and the pair of antenna elements 313a and 313b.

The second antenna element group G2 includes the pair of antenna elements 314a and 314b, the pair of antenna elements 315a and 315b, and the pair of antenna elements 316a and 316b.

The third antenna element group G3 includes the pair of antenna elements 317a and 317b, the pair of antenna elements 318a and 318b, and the pair of antenna elements 319a and 319b.

In FIG. 9, the same hatching is applied to the antenna elements belonging to the second antenna element group G2. In FIG. 9, the same hatching is applied to the antenna elements belonging to the third antenna element group G3. The hatching applied to the antenna elements belonging to the third antenna element group G3 is different from the hatching applied to the antenna elements belonging to the second antenna element group G2. The antenna elements belonging to the first antenna element group G1 are not hatched. As described above, in FIG. 9, the antenna elements belonging to each of the first antenna element group G1, the second antenna element group G2, and the third antenna element group G3 are clearly indicated by presence or absence of hatching and a difference in hatching.

Each of the first antenna element group G1, the second antenna element group G2, and the third antenna element group G3 has three pairs of antenna elements as described above. In a case where one of the three pairs of antenna elements included in each of the first antenna element group G1, the second antenna element group G2, and the third antenna element group G3 is referred to as an i-th pair of antenna elements (i is any one of 1 to 3), the three pairs of antenna elements included in the first antenna element group G1, the second antenna element group G2, and the third antenna element group G3 satisfy the following condition II.

### [Condition II]

The i-th pair of antenna elements in the second antenna element group G2 are disposed at positions obtained by rotating the i-th pair of antenna elements in the first antenna element group G1 by 120 degrees about the predetermined direction of the reference point C, and the i-th pair of antenna elements in the third antenna element group G3 are disposed at positions obtained by rotating the i-th pair of antenna elements in the first antenna element group G1 by 240 degrees about the predetermined direction of the reference point C.

In the mode illustrated in FIG. 9, the i-th pair of antenna elements in each of the first antenna element group G1, the second antenna element group G2, and the third antenna element group G3 and the pairs of antenna elements 311a, 311b, and the like included in the first antenna element group G1, the second antenna element group G2, and the third antenna element group G3 correspond to each other as indicated in Table 1. G1, G2, and G3 in Table 1 correspond to the first antenna element group G1, the second antenna element group G2, and the third antenna element group G3.

TABLE 1

| | | |
|---|---|---|
| G1 | Pair of antenna elements | First pair of antenna elements |
| | 311a and 311b | |
| | Pair of antenna elements | Second pair of antenna elements |
| | 312a and 312b | |
| | Pair of antenna elements | Third pair of antenna elements |
| | 313a and 313b | |
| G2 | Pair of antenna elements | First pair of antenna elements |
| | 314a and 314b | |
| | Pair of antenna elements | Second pair of antenna elements |
| | 315a and 315b | |
| | Pair of antenna elements | Third pair of antenna elements |
| | 316a and 316b | |
| G3 | Pair of antenna elements | First pair of antenna elements |
| | 317a and 317b | |
| | Pair of antenna elements | Second pair of antenna elements |
| | 318a and 318b | |
| | Pair of antenna elements | Third pair of antenna elements |
| | 319a and 319b | |

The above condition II will be specifically described based on the correspondence relationship indicated in Table 1. Here, an arrangement relationship of the pair of antenna elements 311a and 311b, the pair of antenna elements 314a and 314b, and the pair of antenna elements 317a and 317b, which are first pairs of antenna elements of the first antenna element group G1, the second antenna element group G2, and the third antenna element group G3, will be described.

The antenna element 314a of the pair of antenna elements 314a and 314b (the first pair of antenna elements) belonging to the second antenna element group G2 is disposed at a position obtained by rotating the antenna element 311a of the pair of antenna elements 311a and 311b (the first pair of antenna elements) belonging to the first antenna element group G1 clockwise (about the predetermined direction) by an angle θ1 with respect to the reference point C. The angle θ1 is 120 degrees.

The pair of antenna elements 311a and 311b are point-symmetric with respect to the reference point C, and the pair of antenna elements 314a and 314b are point-symmetric with respect to the reference point C. Therefore, the antenna element 314b is also disposed at a position obtained by rotating the antenna element 311b clockwise by the angle θ1 with respect to the reference point C.

Therefore, the pair of antenna elements 314a and 314b are disposed at positions obtained by rotating the pair of antenna elements 311a and 311b clockwise (about a predetermined direction) by the angle θ1 with respect to the reference point C.

The antenna element 317a of the pair of antenna elements 317a and 317b (the first pair of antenna elements) belonging to the third antenna element group G3 is disposed at a position obtained by rotating the antenna element 311a of the pair of antenna elements 311a and 311b (the first pair of antenna elements) belonging to the first antenna element group G1 clockwise (about the predetermined direction) by an angle θ2 with respect to the reference point C. The angle θ2 is 240 degrees.

The pair of antenna elements 311a and 311b are point-symmetric with respect to the reference point C, and the pair of antenna elements 317a and 317b are point-symmetric with respect to the reference point C. Therefore, the antenna element 317b is also disposed at a position obtained by rotating the antenna element 311b clockwise by the angle θ2 with respect to the reference point C.

Therefore, the pair of antenna elements 317a and 317b are disposed at positions obtained by rotating the pair of antenna elements 311a and 311b clockwise by the angle θ2 with respect to the reference point C.

The cases of a second pair of antenna elements and a third pair of antenna elements of the first antenna element group G1, the second antenna element group G2, and the third antenna element group G3 are similar to the case of the first pair of antenna elements.

As illustrated in FIGS. 9 and 10, the antenna main body 30 includes transmission lines 321, 322, 323, 324, 325, 326, 327, 328, and 329 for connecting the antenna elements 311a, 311b, and the like. Electrical lengths of the transmission lines 321, 322, 323, 324, 325, 326, 327, 328, and 329 are the same. In a retroreflective antenna 2C, the antenna elements 311a, 311b, and the like are connected by using a back surface (surface opposite to the surface on which the antenna elements 311a, 311b, and the like are disposed) side of the substrate 33.

The transmission line 321 connects the antenna element 311a and the antenna element 311b (a pair of antenna elements). The transmission line 321 has a portion formed on a back surface 332a of the dielectric layer 332 and a portion formed on the front surface 331a of the dielectric layer 331 and connected to each of the pair of antenna elements 311a and 311b. In the transmission line 321, materials of the portion formed on the front surface 331a and the portion formed on the back surface 332a are the same as those in the case of the transmission line 121 in the first embodiment.

In the transmission line 321, the portion connected to the antenna element 311a and the portion formed on the back surface 332a are connected via a via Vla. In the transmission line 321, the portion connected to the antenna element 311b and the portion formed on the back surface 332a are connected via a via V1b. The vias V1a and V1b are formed by filling a through-hole penetrating the substrate 33 in the thickness direction with a conductive member. In the fourth embodiment, the material of the conductive member of the vias V1a and V1b is the same as the material of the portion of the transmission line 321 formed on the back surface 332a. The via V1a and the via V1b may also be a part of the transmission line 321.

The transmission line 322 connects the antenna element 312a and the antenna element 312b (a pair of antenna elements). The description of the transmission line 322 is the same as the case where the transmission line 321, the antenna element 311a, the antenna element 311b, the via V1a, and the via V1b are replaced with the transmission line 322, the antenna element 312a, the antenna element 312b, a via V2a, and a via V2b in the description of the transmission line 321.

The transmission line 323 connects the antenna element 313a and the antenna element 313b (a pair of antenna elements). The description of the transmission line 323 is the same as the case where the transmission line 321, the antenna element 311a, the antenna element 311b, the via V1a, and the via V1b are replaced with the transmission line 323, the antenna element 313a, the antenna element 313b, a via V3a, and a via V3b in the description of the transmission line 321.

The transmission line 324 connects the antenna element 314a and the antenna element 314b (a pair of antenna elements). The description of the transmission line 324 is the same as the case where the transmission line 321, the antenna element 311a, the antenna element 311b, the via V1a, and the via V1b are replaced with the transmission line 324, the antenna element 314a, the antenna element 314b, a via V4a, and a via V4b in the description of the transmission line 321.

The transmission line 325 connects the antenna element 315a and the antenna element 315b (a pair of antenna elements). The description of the transmission line 325 is the same as the case where the transmission line 321, the antenna element 311a, the antenna element 311b, the via V1a, and the via V1b are replaced with the transmission line 325, the antenna element 315a, the antenna element 315b, a via V5a, and a via V5b in the description of the transmission line 321.

The transmission line 326 connects the antenna element 316a and the antenna element 316b (a pair of antenna elements). The description of the transmission line 326 is the same as the case where the transmission line 321, the antenna element 311a, the antenna element 311b, the via V1a, and the via V1b are replaced with the transmission line 326, the antenna element 316a, the antenna element 316b, a via V6a, and a via V6b in the description of the transmission line 321.

The transmission line 327 connects the antenna element 317a and the antenna element 317b (a pair of antenna elements). The description of the transmission line 327 is the same as the case where the transmission line 321, the antenna element 311a, the antenna element 311b, the via V1a, and the via V1b are replaced with the transmission line 327, the antenna element 317a, the antenna element 317b, a via V7a, and a via V7b in the description of the transmission line 321.

The transmission line 328 connects the antenna element 318a and the antenna element 318b (a pair of antenna elements). The description of the transmission line 328 is the same as the case where the transmission line 321, the antenna element 311a, the antenna element 311b, the via V1a, and the via V1b are replaced with the transmission line 328, the antenna element 318a, the antenna element 318b, a via V8a, and a via V8b in the description of the transmission line 321.

The transmission line 329 connects the antenna element 319a and the antenna element 319b (a pair of antenna elements). The description of the transmission line 329 is the same as the case where the transmission line 321, the antenna element 311a, the antenna element 311b, the via V1a, and the via V1b are replaced with the transmission line 329, the antenna element 319a, the antenna element 319b, a via V9a, and a via V9b in the description of the transmission line 321.

In the transmission lines 321, 322, 323, 324, 325, 326, 327, 328, and 329 (hereinafter, referred to as “transmission lines 321, 322, and the like”), the configurations of the portions on the front surface 331a are the same. The configurations of the vias V1a, V1b, V2a, V2b, V3a, V3b, V4a, V4b, V5a, V5b, V6a, V6b, V7a, V7b, V8a, V8b, V9a, and V9b are also the same.

Therefore, the electrical lengths of the transmission lines 321, 322, and the like are adjusted by the paths of the portions formed on the back surface 332a of the transmission lines 321, 322, and the like. That is, the portions formed on the back surface 332a of the transmission lines 321, 322, and the like are formed such that the electrical lengths of the transmission lines 321, 322, and the like are the same.

In the fourth embodiment, the pairs of antenna elements 311a, 311b, and the like are disposed to satisfy the condition II.

That is, when three pairs of antenna elements included in each of the first antenna element group G1, the second antenna element group G2, and the third antenna element group G3 are each referred to as an i-th pair of antenna elements, the i-th pair of antenna elements in the second antenna element group G2 are disposed at positions obtained by rotating the i-th pair of antenna elements in the first antenna element group G1 by 120 degrees about the predetermined direction of the reference point C, and the i-th pair of antenna elements in the third antenna element group G3 are disposed at positions obtained by rotating the i-th pair of antenna elements in the first antenna element group G1 by 240 degrees about the predetermined direction of the reference point C.

In this case, the transmission lines 321 and the like can be formed to satisfy a condition III.

### [Condition III]

A path of the transmission line connecting the i-th pair of antenna elements in the second antenna element group G2 is a path obtained by rotating a path of the transmission line connecting the i-th pair of antenna elements in the first antenna element group G1 by 120 degrees about the reference point C.

A path of the transmission line connecting the i-th pair of antenna elements in the third antenna element group G3 is a path obtained by rotating the path of the transmission line connecting the i-th pair of antenna elements in the first antenna element group G1 by 240 degrees about the reference point C.

The transmission lines 321 and the like (the portions of the transmission lines 321 and the like on the back surface 322a) illustrated in FIG. 10 are formed to satisfy the condition III. This point will be described based on the correspondence relationship between the pairs of antenna elements 311a, 311b, and the like belonging to the first antenna element group G1, the second antenna element group G2, and the third antenna element group G3 and the first pair of antenna elements, the second pair of antenna elements, and the third pair of antenna elements indicated in Table 1.

Based on the correspondence relationship indicated in Table 1, the first pairs of antenna elements in the first antenna element group G1, the second antenna element group G2, and the third antenna element group G3 are the pair of antenna elements 311a and 311b, the pair of antenna elements 314a and 314b, and the pair of antenna elements 317a and 317b.

As illustrated in FIG. 10, a path of the transmission line 324 connecting the pair of antenna elements 314a and 314b is a path obtained by rotating the transmission line 321 connecting the pair of antenna elements 311a and 311b by 120 degrees about the reference point C. A path of the transmission line 327 connecting the pair of antenna elements 317a and 317b is a path obtained by rotating the transmission line 321 by 240 degrees about the reference point C. Since FIG. 10 is a view when the substrate 33 is viewed from the back surface side, the rotation direction of the transmission line 321 is counterclockwise.

Based on the correspondence relationship in Table 1, the second pairs of antenna elements of the first antenna element group G1, the second antenna element group G2, and the third antenna element group G3 are the pair of antenna elements 312a and 312b, the pair of antenna elements 315a and 315b, and the pair of antenna elements 318a and 318b.

As illustrated in FIG. 10, a path of the transmission line 325 connecting the pair of antenna elements 315a and 315b is a path obtained by rotating the transmission line 322 connecting the pair of antenna elements 312a and 312b by 120 degrees about the reference point C. A path of the transmission line 328 connecting the pair of antenna elements 318a and 318b is a path obtained by rotating the transmission line 322 by 240 degrees about the reference point C. Since FIG. 10 is a view when the substrate 33 is viewed from the back surface side, the rotation direction of the transmission line 322 is counterclockwise.

Based on the correspondence relationship in Table 1, the third pairs of antenna elements of the first antenna element group G1, the second antenna element group G2, and the third antenna element group G3 are the pair of antenna elements 313a and 313b, the pair of antenna elements 316a and 316b, and the pair of antenna elements 319a and 319b.

As illustrated in FIG. 10, a path of the transmission line 326 connecting the pair of antenna elements 316a and 316b is a path obtained by rotating the transmission line 323 connecting the pair of antenna elements 313a and 313b by 120 degrees about the reference point C. A path of the transmission line 329 connecting the pair of antenna elements 319a and 319b is a path obtained by rotating the transmission line 323 by 240 degrees about the reference point C. Since FIG. 10 is a view when the substrate 33 is viewed from the back surface side, the rotation direction of the transmission line 323 is counterclockwise.

A stub (notch filter) S is provided in each of the transmission lines 321, 322, 323, 324, 325, 326, 327, 328, and 329. As illustrated in FIG. 10, in the fourth embodiment, the stub S is provided in a portion of the transmission lines 321 and the like on the back surface 332a. Since the arrangement mode of the stub S and the conditions satisfied by the stub S are the same as those of the stub S described in the first embodiment, the description thereof will be omitted.

The transmission lines 321, 322, and the like and the stubs S can also be formed by, for example, a printing technique.

As described above, the pairs of antenna elements 311a, 311b, and the like satisfy the condition I, and the electrical lengths of the transmission lines 321 and the like connecting the pairs of antenna elements 311a, 311b, and the like are the same. Therefore, the antenna main body 30 of the retroreflective antenna 2B also functions as the Van Atta array antenna. Therefore, the retroreflective antenna 2B can also retroreflect the radio waves incoming to the retroreflective antenna 2B. Furthermore, a stub S that is a passive notch filter is provided in the transmission lines 321 and the like. Therefore, as in the case of the first embodiment, it is possible to superimpose information corresponding to the retroreflective antenna 2B on the radio waves retroreflected by the retroreflective antenna 2B. Therefore, the retroreflective antenna 2B has the same effects as those of the retroreflective antenna 2.

In the fourth embodiment, the back surface side of the substrate 33 is used for connection of the pairs of antenna elements 311a, 311b, and the like by the transmission lines 321, 322, and the like. Therefore, even when the pairs of antenna elements 311a, 311b, and the like are two-dimensionally disposed, the degree of freedom in path design of the transmission lines 321 and the like is improved.

In the retroreflective antenna 2B, the arrangement relationship of the pairs of antenna elements 311a, 311b, and the like satisfies the condition II. Therefore, the transmission lines 321, 322, and the like can also be formed to satisfy the condition III. In this case, the retroreflective antenna 2B can be easily designed. This point will be described.

When the retroreflective antenna 2B is designed, the antenna elements 311a, 311b, 312a, 312b, 313a, and 313b belonging to the first antenna element group G1 and the transmission lines 321, 322, and 323 connecting them are designed. Next, the pair of antenna elements 311a and 311b, the pair of antenna elements 312a and 312b, the pair of antenna elements 313a and 313b, and the transmission lines 321, 322, and 323 are rotated by 120 degrees and 240 degrees about the reference point C so as to satisfy the above conditions II and III. Thus, the configurations and arrangements of the antenna elements 314a, 314b, 315a, 315b, 316a, 316b, 317a, 317b, 318a, 318b, 319a, and 319b belonging to the second antenna element group G2 and the third antenna element group G3 and the transmission lines 324, 325, 326, 327, 328, and 329 are also determined.

Therefore, when the retroreflective antenna 2B is designed, when 1/3 of the retroreflective antenna 2B is designed, the retroreflective antenna 2B can be substantially designed. As described above, since the retroreflective antenna 2B is easily designed, the retroreflective antenna 2B is also easily manufactured.

The retroreflective antenna 2B can be applied to the object detecting system 1 described in the second embodiment.

Although various embodiments of the present disclosure have been described above, the present disclosure is not limited to the illustrated embodiments, and various modifications are possible.

The notch filter is not limited to a stub as long as it is a passive notch filter and is configured to cut a part of a frequency in a frequency band (frequency modulation width when frequency modulation is performed) of radio waves incoming to the retroreflective antenna. For example, the notch filter may be configured by using passive elements such as a coil, a capacitor, and a resistor.

The radio waves reflected by the retroreflective antenna and the radio waves transmitted by the radar device described in the second embodiment are not limited to millimeter waves. The radio waves may be, for example, microwaves or sub-millimeter waves.

The number of pairs of antenna elements, transmission lines, and notch filters included in the retroreflective antenna is not limited to the illustrated number. In the fourth embodiment, the number of pairs of antenna element groups included in each of the first antenna element group, the second antenna element group, and the third antenna element group is not limited to three. That is, when each of the first antenna element group, the second antenna element group, and the third antenna element group has N pairs of antenna element groups, N may be one or two, or four or more. When each of the first antenna element group, the second antenna element group, and the third antenna element group has N pairs of antenna element groups, i in the i-th pair of antenna elements is an integer of 1 or more and N or less.

The mode in which the passive notch filter is provided in all of the plurality of transmission lines included in the retroreflective antenna has been described. However, it is sufficient that the passive notch filter is provided in at least one transmission line among the plurality of transmission lines included in the retroreflective antenna. For example, in the mode in which one of the plurality of transmission lines is provided with a passive notch filter, a part of radio waves propagating through the transmission line provided with the passive notch filter can be attenuated. As a result, information based on the passive notch filter can be superimposed on the radio waves retroreflected from the retroreflective antenna. As described in the above embodiment, in the mode in which the passive notch filter is provided in all of the plurality of transmission lines included in the retroreflective antenna, reflected power of a portion of the radio waves cut by the passive notch filter can be attenuated more greatly. Therefore, the retroreflective antenna or the object to which the retroreflective antenna is attached can be detected with high accuracy.

In the fourth embodiment, the mode in which a plurality of antenna elements are disposed so as to form two hexagons having different sizes has been described. However, depending on the number and size of the antenna elements in the retroreflective antenna, the plurality of antenna elements may be disposed to form one hexagon, or may be disposed to form three or more different sizes of hexagons.

When the plurality of antenna elements are two-dimensionally disposed, the arrangement mode of the plurality of antenna elements is not limited to the mode in which the antenna elements are disposed in a hexagonal shape as described in the fourth embodiment. For example, the plurality of antenna elements may be disposed in a quadrangular shape.

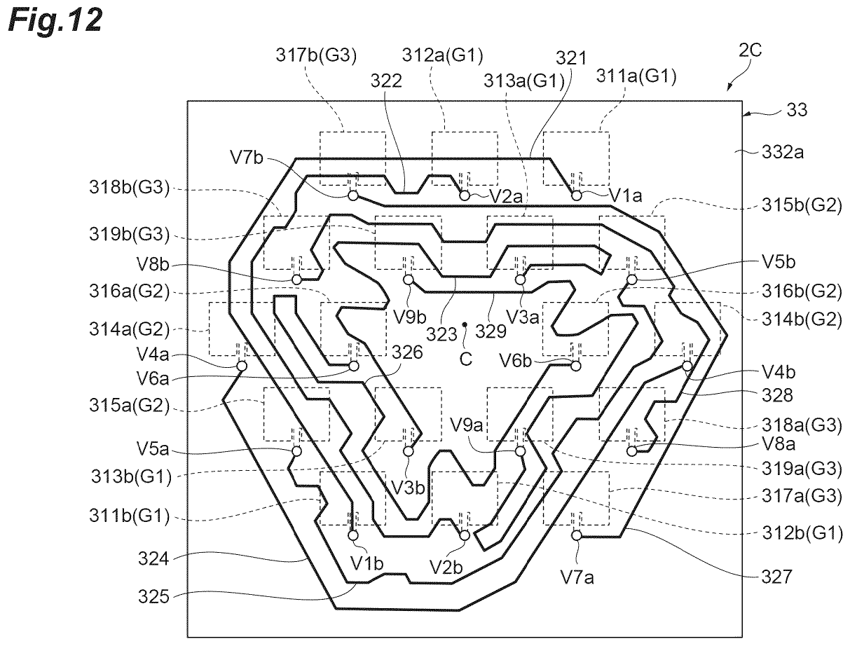

FIG. 12 is a schematic view of another embodiment of the retroreflective antenna. The retroreflective antenna 2C illustrated in FIG. 12 is different from the retroreflective antenna illustrated in FIGS. 9 and 10 in not including the stub S. Other than this difference, the configuration of the retroreflective antenna 2C is the same as the configuration of the retroreflective antenna 2B. Therefore, the retroreflective antenna 2C also includes a first antenna element group G1, a second antenna element group G2, and a third antenna element group G3. Further, an arrangement relationship among the plurality of antenna elements belonging to the first antenna element group G1, the second antenna element group G2, and the third antenna element group G3 satisfies the condition II. Therefore, the retroreflective antenna 2C is easily designed similarly to the case of the retroreflective antenna 2B. As a result, it is easy to manufacture the retroreflective antenna.

As described above, from the viewpoint of ease of design, a retroreflective antenna may be an retroreflective antenna which includes an antenna main body for retroreflecting incoming radio waves, wherein the antenna main body includes a plurality of pairs of antenna elements and a plurality of transmission lines provided corresponding to the plurality of pairs of antenna elements, each pair of antenna elements in the plurality of pairs of antenna elements is disposed point-symmetrically with respect to a reference point in the antenna main body, each of the plurality of transmission lines connects a corresponding pair of antenna elements among the plurality of pairs of antenna elements, electrical lengths of the plurality of transmission lines are the same, the at least one passive notch filter is provided in at least one transmission line among the plurality of transmission lines, the plurality of pairs of antenna elements are virtually divided into a first antenna element group, a second antenna element group, and a third antenna element group, each of the first antenna element group, the second antenna element group, and the third antenna element group includes N (N is an integer of 1 or more) pairs of antenna elements, when one of the N pairs of antenna elements in each of the first antenna element group, the second antenna element group, and the third antenna element group is an i-th pair of antenna elements (i is 1 or more and N or less), the i-th pair of antenna elements in the second antenna element group are disposed at positions obtained by rotating the i-th pair of antenna elements in the first antenna element group by 120 degrees about a predetermined direction of the reference point, and the i-th pair of antenna elements in the third antenna element group are disposed at positions obtained by rotating the i-th pair of antenna elements in the first antenna element group by 240 degrees about the predetermined direction of the reference point.

The various embodiments and modifications described above may be appropriately combined without departing from the gist of the present disclosure.

### REFERENCE SIGNS LIST

1 object detecting system
2, 2A, 2B, 2C Retroreflective antenna
3 Radar device
3a Radar main body
3b Control device
4 Radio waves
5 Object
10 Antenna main body
111a Antenna element
111b Antenna element
112a Antenna element
112b Antenna element
113a Antenna element
113b Antenna element
121 Transmission line
122 Transmission line
123 Transmission line
13 Substrate
131 Dielectric layer
132 Ground conductor layer
131b Back surface
131a Front surface
21 Notch filter (passive notch filter)
22 Notch filter (passive notch filter)
23 Notch filter (passive notch filter)
24 Notch filter group
24a Notch filter (passive notch filter)
24b Notch filter (passive notch filter)
24c Notch filter (passive notch filter)
25 Notch filter group
25a Notch filter (passive notch filter)
25b Notch filter (passive notch filter)
25c Notch filter (passive notch filter)
26 Notch filter group
26a Notch filter (passive notch filter)
26b Notch filter (passive notch filter)
26c Notch filter (passive notch filter)
30 Antenna main body
311a Antenna element
311b Antenna element
312a Antenna element
312b Antenna element
313a Antenna element
313b Antenna element
314a Antenna element
314b Antenna element
315a Antenna element
315b Antenna element
316a Antenna element
316b Antenna element
317a Antenna element
317b Antenna element
318a Antenna element
318b Antenna element
319a Antenna element
319b Antenna element
321 Transmission line
322 Transmission line
323 Transmission line
324 Transmission line
325 Transmission line
326 Transmission line
327 Transmission line
328 Transmission line
329 Transmission line
33 Substrate
331 Dielectric layer
331a Front surface
332 Dielectric layer
322a Back surface
333 Conductor layer
C Reference point
G1 First antenna element group
G2 Second antenna element group
G3 Third antenna element group
L Length
S Stub (passive notch filter)
V1a Via
V1b Via
V2a Via
V2b Via
V3a Via
V3b Via
V4a Via
V4b Via
V5a Via
V5b Via
V6a Via
V6b Via
V7a Via
V7b Via
V8a Via
V8b Via
V9a Via
V9b Via
θ1 Angle
θ2 Angle

1. A retroreflective antenna comprising:
an antenna main body for retroreflecting incoming radio waves; and
a passive notch filter, wherein
the antenna main body includes
a plurality of pairs of antenna elements, and
a plurality of transmission lines provided corresponding to the plurality of pairs of antenna elements,
each pair of antenna elements in the plurality of pairs of antenna elements is disposed point-symmetrically with respect to a reference point in the antenna main body,
each of the plurality of transmission lines connects corresponding pair of antenna elements among the plurality of pairs of antenna elements,
electrical lengths of the plurality of transmission lines are the same, and
the passive notch filter is provided in at least one transmission line among the plurality of transmission lines.

2. The retroreflective antenna according to claim 1, wherein
the plurality of pairs of antenna elements include a first antenna element group, a second antenna element group, and a third antenna element group,
each of the first antenna element group, the second antenna element group, and the third antenna element group includes N (N is an integer of 1 or more) pairs of antenna elements, and
when one of the N pairs of antenna elements in each of the first antenna element group, the second antenna element group, and the third antenna element group is defined as an i-th pair of antenna elements (i is 1 or more and N or less),
the i-th pair of antenna elements in the second antenna element group are disposed at positions obtained by rotating the i-th pair of antenna elements in the first antenna element group by 120 degrees about a predetermined direction of the reference point, and
the i-th pair of antenna elements in the third antenna element group are disposed at positions obtained by rotating the i-th pair of antenna elements in the first antenna element group by 240 degrees about the predetermined direction of the reference point.

3. The retroreflective antenna according to claim 1, wherein
a plurality of the passive notch filters are included,
a number of the plurality of passive notch filters is the same as a number of the plurality of transmission lines,
frequencies cut by the plurality of passive notch filters are the same, and
each transmission line included in the plurality of transmission lines is provided with each passive notch filter included in the plurality of passive notch filters.

4. The retroreflective antenna according to claim 1, wherein
a plurality of notch filter groups are included,
each notch filter group in the plurality of notch filter groups includes a plurality of the passive notch filters configured to cut different frequencies,
a number of the plurality of notch filter groups is the same as a number of the plurality of transmission lines, and
each notch filter group in the plurality of notch filter groups is provided in each transmission line in the plurality of transmission lines.

5. An object detecting system comprising:
a retroreflective antenna attached to an object and being the retroreflective antenna according to claim 1; and
a radar device configured to transmit radio waves modulated by an FMCW method and receive the radio waves retroreflected by the retroreflective antenna, wherein
a frequency cut by the passive notch filter included in the retroreflective antenna is a frequency within a frequency band of the radio waves.

6. The object detecting system according to claim 5, wherein
a plurality of notch filter groups are included,
each notch filter group in the plurality of notch filter groups includes a plurality of the passive notch filters configured to cut different frequencies,
a number of the plurality of notch filter groups is the same as a number of the plurality of transmission lines, and
each notch filter group in the plurality of notch filter groups is provided in each transmission line in the plurality of transmission lines.
